(19) United States
(12) Patent Application Publication
(10) Pub. No.: US 2006/0107853 A1
(43) Pub. Date: May 25, 2006

(54) Method and apparatus for applying a medium to a printing form

(76) Inventors: Josef Goettling, Friedberg (DE); Godber Petersen, Augsburg (DE); Thomas Hartmann, Mering (DE); Herbert Langer, Oberndorf (DE); Alfons Schuster, Augsburg (DE); Michael Wagner, Augsburg (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/240,906

(22) Filed: Sep. 30, 2005

(30) Foreign Application Priority Data
Sep. 30, 2004 (DE) 10 2004 047 456.7

(51) Int. Cl. B41L 25/00

(52) U.S. Cl. 101/148

(57) ABSTRACT

A method and apparatus for applying a medium, especially a conditioning medium or a rubber covering medium, to a printing form positioned on a form cylinder, especially to a rewritable and erasable printing form, is disclosed. The medium is applied to a rubber covered cylinder or to a separate applicator roll or an applicator cylinder for the medium, the medium then being transferred from the rubber covered cylinder or applicator roll or applicator cylinder to the form cylinder, in this case the rubber covered cylinder, the applicator roll or the applicator cylinder rolling repeatedly over the form cylinder in order to ensure a uniform application of the medium to the printing form.

This application claims the priority of German Patent Document No. 10 2004 047 456.7, filed Sep. 30, 2004, the disclosure of which is expressly incorporated by reference herein.

### BACKGROUND AND SUMMARY OF THE INVENTION

The invention relates to a method for applying a medium, especially a conditioning medium or a rubber covering medium, to a printing form, especially to a rewritable and erasable printing form. Furthermore, the invention relates to an apparatus for applying a medium, especially a conditioning medium or a rubber covering medium, to a printing form, especially to a rewritable and erasable printing form.

When printing with a printing form, a distinction is in principle drawn between methods which, on the one hand, operate with a printing form which can be written once and, on the other hand, operate with a rewritable printing form. Printing methods which use rewritable printing forms are also summarized under the keyword “computer to press/direct imaging”. The applicant markets digital presses which operate with rewritable and erasable printing forms, under the product description “DICOweb”. The principles of “DICOweb” technology are described in “Handbuch der Printmedien [Handbook of print media], Helmut Kipphan, pages 674 to 680, year 2000, Springer-Verlag”.

During the production of such rewritable and erasable “DICOweb” printing forms, a form cylinder is preferably subjected to an imaging step and a de-imaging step. Following the imaging, the printing form is fixed and conditioned, it being possible for the conditioning also to be carried out before or after the fixing. The conditioning of the printing form is used inter alia to reinforce printing and non-printing regions of the printing form and also to make the non-printing regions of the printing form hydrophilic. Furthermore, in printing technology it is already common to provide printing forms with rubber coverings on their surfaces in order to protect the same against contamination or damage by atmospheric acid. A rubber covering medium is intended to conserve and maintain the printing technical differentiation, in particular with respect to carrying ink and/or water.

During rubber covering of the printing form, the rubber covering medium must be applied to the printing form but, on the other hand, during conditioning a conditioning medium must be applied. The present invention relates to an apparatus and a method for the careful and uniform application of a conditioning medium or a rubber covering medium to a printing form, especially to a rewritable and erasable printing form for presses.

German Patent Document No. DE 40 13 464 C2 discloses a method and an apparatus for rubber covering a printing form of a conventional press; according to DE 40 13 464 C2 the rubber covering medium needed for the rubber covering being applied to the printing form via a damping solution applicator roll of a damping unit of the press. The disadvantage with this application, known from the prior art, of the rubber covering medium via the damping solution applicator roll is that the lifetime and the properties of the damping solution applicator roll are influenced detrimentally in this way and that there is the risk of contamination of the damping solution as a result of the ingress of dirt particles. Furthermore, the residual ink normally found on the damping solution applicator roll is disadvantageous for the rubber covering operation. The application, known from the prior art, of the rubber covering medium via the damping unit of the press is accordingly disadvantageous overall.

On this basis, the present invention is based on the problem of providing a novel type of method for applying a medium, especially a conditioning medium or a rubber covering medium, to a printing form, especially to a rewritable and erasable printing form.

This problem is solved by a method of the present invention. According to the invention, the medium, especially the conditioning medium or the rubber covering medium, is applied to a rubber covered cylinder or to a separate applicator cylinder for the medium or to a smoothing roll, the medium then being transferred from the rubber covered cylinder or applicator roll to the form cylinder and in this case the rubber covered cylinder or the applicator roll rolling repeatedly over the form cylinder in order to ensure a uniform application of the medium to the printing form. The medium can also be applied to the form cylinder directly, especially by means of a spraying device or a cloth, in particular a cleaning cloth of a washing device, or a brush, especially of a brush washing device.

In the sense of the present invention, it is preferably provided to apply the conditioning medium or the rubber covering medium to a rubber covered cylinder or a separate applicator roll and then to transfer the conditioning medium or rubber covering medium from the rubber covered cylinder or from the separate applicator roll to the form cylinder and therefore to the printing form. In the process, the rubber covered cylinder or the separate applicator roll rolls repeatedly over the form cylinder or the printing form positioned on the form cylinder, in order in this way to ensure a uniform application of the conditioning medium or rubber covering medium to the printing form. If the rubber covered cylinder is used to apply the medium, it is possible to dispense with a separate applicator cylinder. Furthermore, following the application of the conditioning medium or rubber covering medium to the form cylinder or to the printing form positioned on the form cylinder, the rubber covered cylinder may be cleaned with the aid of a washing device assigned to the rubber covered cylinder.

According to a preferred development of the invention, when transferring the medium to the printing form, the rubber covered cylinder or the applicator cylinder is driven in such a way that a surface speed of the rubber covered cylinder or of the separate applicator cylinder corresponds approximately to a surface speed of the form cylinder. This means that particularly careful application of the medium to the printing form is possible.

An apparatus according to the invention for applying a medium, especially a conditioning medium or a rubber covering medium, to a printing form, especially to a rewritable and erasable printing form, is also provided.

### BRIEF DESCRIPTION OF THE DRAWINGS

Preferred developments of the invention emerge from the following description. Exemplary embodiments of the invention will be explained in more detail, without being restricted hereto, by using the drawings.

FIG. 1 shows an apparatus according to the invention for applying a medium, specifically a conditioning medium or a rubber covering medium, to a printing form according to a first exemplary embodiment of the invention.

FIG. 2 shows the apparatus of FIG. 1 when applying the medium to a rubber covered cylinder.

FIG. 3 shows the apparatus of FIGS. 1 and 2 when transferring the medium from the rubber covered cylinder to a form cylinder or the printing form.

FIG. 4 shows the apparatus of FIGS. 1 to 3 when cleaning the rubber covered cylinder.

FIG. 5 shows an apparatus according to the invention for applying a medium, specifically a conditioning medium or a rubber covering medium, to a printing form according to a second exemplary embodiment of the invention.

FIG. 6 shows an apparatus according to the invention for applying a medium, specifically a conditioning medium or a rubber covering medium, to a printing form according to a third exemplary embodiment of the invention.

FIG. 7 shows an apparatus according to the invention for applying a medium, specifically a conditioning medium or a rubber covering medium, to a printing form according to a fourth exemplary embodiment of the invention.

FIG. 8 shows an apparatus according to the invention for applying a medium, specifically a conditioning medium or a rubber covering medium, to a printing form according to a further exemplary embodiment of the invention.

FIG. 8a shows an apparatus according to the invention for applying a medium, specifically a conditioning medium or a rubber covering medium, to a printing form according to a modified exemplary embodiment of the invention according to FIG. 8.

FIG. 9 shows an apparatus according to the invention for applying a medium, specifically a conditioning medium or a rubber covering medium, to a printing form according to a further exemplary embodiment of the invention.

FIG. 10 shows an apparatus according to the invention for applying a medium, specifically a conditioning medium or a rubber covering medium, to a printing form according to a further exemplary embodiment of the invention.

FIG. 11 shows an apparatus according to the invention for applying a medium, specifically a conditioning medium or a rubber covering medium, to a printing form according to a further exemplary embodiment of the invention.

FIG. 12 shows an apparatus according to the invention for applying a medium, specifically a conditioning medium or a rubber covering medium, to a printing form according to a further exemplary embodiment of the invention.

### DETAILED DESCRIPTION OF THE DRAWINGS

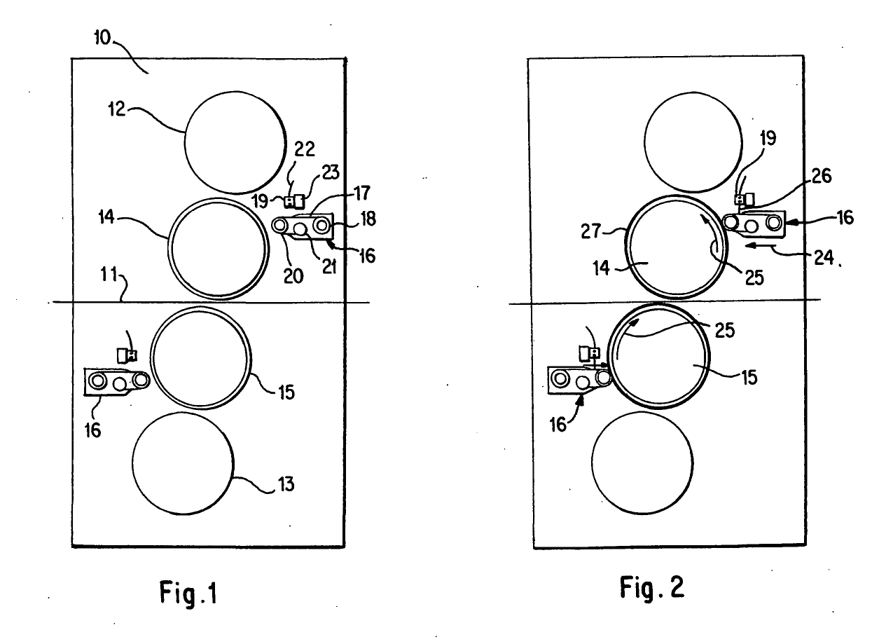

In the following text, with reference to FIGS. 1 to 9, the invention will be described by way of example for offset printing in accordance with the “DICOweb” technology, the offset printing variant of the “DICOweb” technology also being designated “DICOweb litho”. Of course, the invention is not intended to be restricted to the “DICOweb” technology but also to be generally applicable in presses with erasable imaging.

FIGS. 1 to 4 show a preferred exemplary embodiment of the present invention for applying a medium, specifically a conditioning medium or a rubber covering medium, to a printing form positioned on a form cylinder. Thus, FIGS. 1 to 4 show a printing unit 10 of a web-fed press, a web printing material 11 being printed on an upper side and underside of the same in the printing unit 10. In order to print the printing material 11 on the upper side and the underside, the printing unit 10 according to FIG. 1 has two form cylinders 12, 13 and two rubber covered cylinders 14, 15, the form cylinder 12 interacting with the rubber covered cylinder 14 in order to print the upper side of the printing material 11, and the form cylinder 13 interacting with the rubber covered cylinder 15 in order to print the underside of the printing material 11. Positioned on the form cylinders 12, 13 are printing forms which are designed as rewritable and erasable printing forms, in particular in accordance with the “DICOweb” principle.

As can be gathered from FIG. 1, each of the rubber covered cylinders 14 and 15 is assigned a washing device 16 in each case, it being possible in each of the washing devices 16 for a cleaning cloth 17 to be pulled off a clean cloth roll 18, sprayed with cleaning liquid by a spraying device 19 and then for the clean cleaning cloth 17 sprayed with cleaning liquid to be brought into contact with the respective rubber covered cylinder 14, 15 via pressing elements 20. The respective rubber covered cylinder 14 or 15 can then be cleaned by the cleaning cloth 17 wetted with cleaning medium, contaminated cleaning cloth being wound up on a dirty cloth roll 21. The cleaning medium is supplied to the spraying device 19 via a feed line 22.

At this point, it should be pointed out that the cleaning described above and known from the prior art of the rubber covered cylinders 14 and 15 with the aid of the respective washing device 16 can be carried out either over the width of the cylinder or by traversing section by section or by traversing continuously. In the case of cleaning the rubber covered cylinders 14 and 15 by traversing section by section, the washing devices 16 are moved in the direction of a longitudinal axis or axis of rotation of the rubber covered cylinders 14 and 15, the rubber covered cylinders 14 and 15 then being cleaned only in the region in which the clean cloth actually comes into contact with the surface of the rubber covered cylinders 14 and 15 via the pressing element 20. In the exemplary embodiment of FIG. 1, cleaning the rubber covered cylinders 14 and 15 by traversing section by section is carried out by the washing devices 16, it being possible for the spraying device 19 to be moved along a crossmember 23 in the direction of the longitudinal axis or axis of rotation of the rubber covered cylinders 14 and 15, relative to the surface of the same. The above configuration of a printing unit 10 is, according to the prior art, only used for cleaning the rubber covered cylinders 14 and 15.

It is now within the sense of the exemplary embodiment of FIGS. 2 to 4 to apply a rubber covering medium or conditioning medium with the aid of the washing devices and the rubber covered cylinders to the printing forms respectively positioned on the form cylinders. For this purpose, the procedure as demonstrated in FIGS. 2 to 4 is followed.

Thus, in a first step, with the aid of the washing devices 16 (see FIG. 2), the rubber covering medium or the conditioning medium is applied to the rubber covered cylinders 14 and 15. For this purpose, the washing device 16 is set against the respective rubber covered cylinder 14 or 15 in the direction of the arrow 24, and the rubber covered cylinders 14 and 15 are set rotating in the direction of the arrows 25. The conditioning medium or rubber covering medium is applied to the appropriate cleaning cloth in the direction of the arrow 26 by the spraying device 19, which is normally used for applying a cleaning medium to the cleaning cloth 17. The conditioning medium or rubber covering medium applied to the cleaning cloth with the aid of the spraying device 19 is then transferred via the pressing element 20 to the rubber covered cylinder 14 or 15, so that a film 27 of conditioning medium or rubber covering medium is built up on the surface of the rubber covered cylinder 14 or 15.

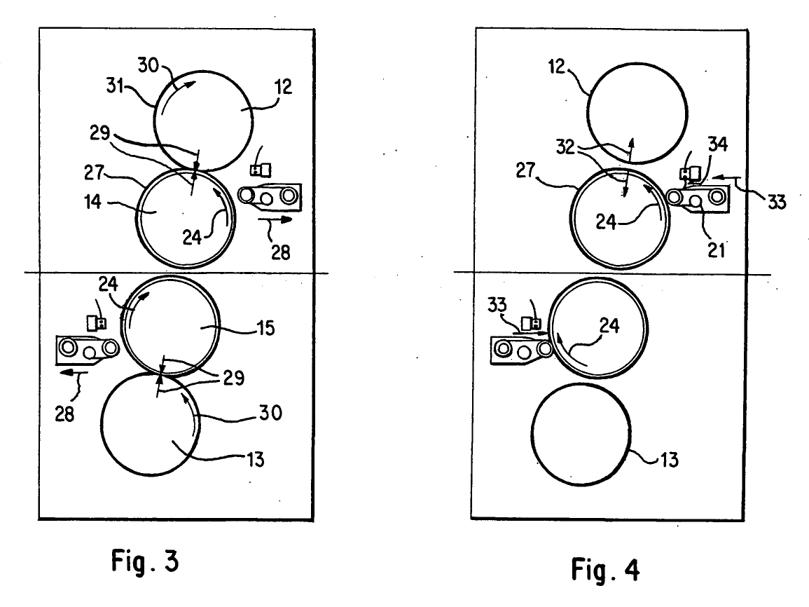

After the conditioning medium or rubber covering medium has been applied to the respective rubber covered cylinder 14 or 15 to the desired extent with the aid of the washing devices 16, the washing device 16 is withdrawn from the respective rubber covered cylinder in the direction of the arrow 28 (see FIG. 3) and, by means of relative movement between the form cylinder 12 or 13 and the associated rubber covered cylinder 14 or 15, contact is made between the form cylinder 12 or 13 and the respective rubber covered cylinder 14 or 15. The setting operation between the form cylinder 12 or 13 and the respective rubber covered cylinder 14 or 15 is visualized in FIG. 3 by arrows 29. When the form cylinder 12 or 13 is set against the respective rubber covered cylinder 14 or 15, both the rubber covered cylinders 14 and 15 are moved in rotation in the direction of the arrows 24 and the form cylinders 12 and 13 are moved in rotation in the direction of the arrows 30. In the process, the conditioning medium or rubber covering medium applied to the rubber covered cylinder 14 or 15 is transferred to the respective form cylinder 12 or 13, specifically to the printing form positioned on the respective form cylinder 12 or 13. Here, a film 31 of the conditioning medium or rubber covering medium builds up on the surface of the respective form cylinder 12 or 13, specifically of the corresponding printing form.

As a result of the respective rubber covered cylinder 14 or 15 rolling repeatedly on the form cylinder 12 or 13, a uniform distribution of the conditioning medium or of the rubber covering medium on the printing form to be wetted of the respective form cylinder 12 or 13 is ensured.

After the conditioning medium or rubber covering medium has been transferred in the manner described above from the rubber covered cylinder 14 or 15 to the respective form cylinder 12 or 13, specifically to the printing form positioned on the respective form cylinder, cleaning of the rubber covered cylinder 14 or 15 with the aid of the washing devices 16 is carried out in the sense of FIG. 4. The form cylinder 12 or 13 wetted with conditioning medium or rubber covering medium is set off the respective rubber covered cylinder 14 or 15 in the direction of the arrows 32, and the washing devices 16 are set onto the respective rubber covered cylinder 14 or 15 in the direction of the arrows 33. A cleaning medium is then applied to the cleaning cloth via the spraying device 19 and, in this way, the residual film of conditioning medium or rubber covering medium on the respective rubber covered cylinder 14 or 15 is removed from the rubber covered cylinder 14 or 15. The application of the cleaning liquid to the cleaning cloth is illustrated in FIG. 4 by the arrow 34.

In the exemplary embodiment of FIGS. 1 to 4, accordingly, in the sense of the present invention, a conditioning medium or rubber covering medium is applied to the printing form positioned on a form cylinder in such a way that, first of all, the conditioning medium or rubber covering medium is applied to rubber covered cylinders interacting with the form cylinders via a washing device present in any case in the printing unit, the film of conditioning medium or rubber covering medium applied in this way to the rubber covered cylinders then being transferred from the rubber covered cylinder to the respective form cylinder as a result of the form cylinder and corresponding rubber covered cylinder rolling repeatedly over each other. In this way, in a careful manner, a uniform conditioning medium film or rubber covering medium film can be applied to the printing form positioned on the corresponding form cylinder. The cleaning of the rubber covered cylinders with the aid of the washing devices is then carried out.

In the sense of the present invention, particularly careful application of the conditioning medium or rubber covering medium to the printing form of the form cylinder 12 or 13 can be achieved if, during the transfer of the conditioning medium or rubber covering medium from the rubber covered cylinder 14 or 15 to the respective form cylinder 12 or 13 (see FIG. 3), the form cylinder and rubber covered cylinder are driven in such a way that a surface speed of the rubber covered cylinder 14 or 15 corresponds to the surface speed of the corresponding form cylinder 12 or 13. As a result of avoiding a difference in speed on the surfaces of the rubber covered cylinder and form cylinder, it is possible to avoid the printing form being stressed or damaged when transferring the conditioning medium or rubber covering medium from the rubber covered cylinder to the respective form cylinder.

Furthermore, it should be pointed out that, in the exemplary embodiment of FIGS. 1 to 4, a configuration is preferred in which both the conditioning medium and rubber covering medium and, subsequently, the cleaning medium are applied to the cleaning cloth of the washing devices 16 via the same nozzle belonging to the spraying device 19. The advantage of a nozzle used jointly in such a way is that, following the application of the rubber covering medium or conditioning medium, cleaning of the nozzle is carried out automatically, so that the risk of drying out and therefore failure of the nozzle can be reduced or ruled out.

As already mentioned, in the exemplary embodiment of FIGS. 1 to 4, the application of the rubber covering medium or conditioning medium to the corresponding rubber covered cylinder 14 or 15 is carried out by traversing section by section, for this purpose the washing devices 16 with the associated spraying devices 19 being moved in the direction of an axis of rotation or longitudinal central axis of the rubber covered cylinders 14 and 15, along a surface of the same. However, non-traversing washing devices 16 and spraying devices 19, with the aid of which the conditioning medium or rubber covering medium can be applied to the rubber covered cylinder 14 or 15 over the width of the cylinder in one step, can also be used in the sense of the present invention.

In the exemplary embodiment of FIGS. 1 to 4, the conditioning medium or rubber covering medium is accordingly transferred to the form cylinder by using the rubber covered cylinders which are present in any case, the application of the conditioning medium or rubber covering medium to the rubber covered cylinders being carried out indirectly via the cleaning cloth 17 of the washing devices 16. It should be pointed out that, in the sense of the present invention, the conditioning medium or rubber covering medium can of course also be applied directly to the rubber covered cylinders 14 and 15 of FIGS. 1 to 4, in that, for example, a spraying device is aimed directly at the rubber covered cylinders 14 and 15. The immediate or direct spraying of conditioning medium or rubber covering medium onto the rubber covered cylinders is preferably carried out when the rubber covered cylinders are already in contact with the respective form cylinder. A pinch point between rubber covered cylinders and form cylinders in this case evens out the application of the conditioning medium or rubber covering medium to the form cylinders.

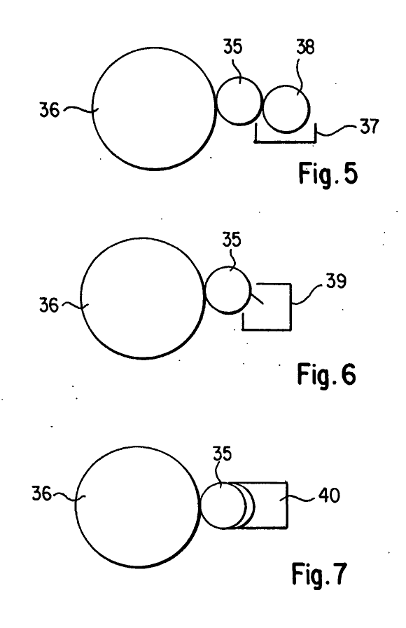

FIGS. 5 to 9 show highly schematic exemplary embodiments of the present invention, in which the conditioning medium or rubber covering medium is applied directly to a form cylinder 36 with the aid of a separate applicator cylinder 35. The common factor in all the exemplary embodiments according to FIGS. 5 to 9 is that the conditioning medium or rubber covering medium is first applied to the separate applicator cylinder 35 and the conditioning medium or rubber covering medium is then transferred from the separate applicator cylinder 35 to the form cylinder 36, in this case the applicator cylinder 35 rolling repeatedly over the form cylinder 36. Here, cylinder-wide designs or those traversing section by section or traversing continuously are also possible.

During the transfer of the conditioning medium or rubber covering medium from the separate applicator cylinder 35 to the respective form cylinder 36, applicator cylinder 35 and form cylinder 36 are driven in such a way that a surface speed of the applicator cylinder 35 corresponds approximately to the surface speed of the form cylinder 36. In this way, particularly careful application of the rubber covering medium or conditioning medium to the printing form positioned on the form cylinder 36 can be carried out without the risk of damaging the same. The drive of the applicator cylinder 35 can also be carried out by means of friction, one part of the applicator cylinder 35 always remaining dry in order to ensure the necessary frictional force.

The exemplary embodiments according to FIGS. 5 to 9 differ only in the details which relate to the application of the conditioning medium or rubber covering medium to the separate applicator roll 35.

In the exemplary embodiment of FIG. 5, conditioning medium or rubber covering medium is kept ready in a dip bath 37, an intermediate cylinder 38 which transfers the rubber covering medium or conditioning medium to the applicator roll 35 projecting into the dip bath 37.

In the exemplary embodiment of FIG. 6, the application of the conditioning medium or rubber covering medium to the separate applicator roll 35 is carried out via a doctor device 39, preferably via a metering rod.

In the exemplary embodiment of FIG. 7, the application of the conditioning medium or rubber covering medium to the separate applicator roll 35 is carried out via a thin-film producing device 40. In the thin-film producing device 40 of the exemplary embodiment of FIG. 7, the conditioning medium or rubber covering medium is kept ready in a chamber and the medium is transferred to the separate applicator roll 35 without contact as a result of a relative movement between the separate applicator roll 35 and the chamber 40. For this purpose, between the chamber and the separate applicator roll 35 a closely defined gap is maintained, this gap performing a sealing function when the applicator roll 35 is at a standstill, so that no conditioning medium or rubber covering medium can emerge from the chamber of the thin-film producing device 40.

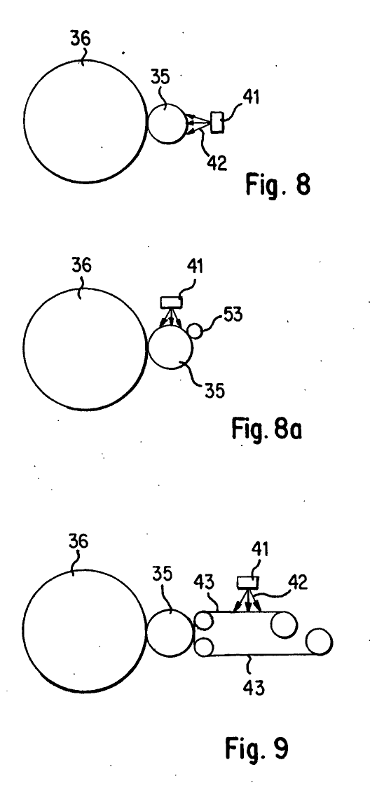

In the exemplary embodiment of FIGS. 8 and 8a, the application of the conditioning medium or rubber covering medium to the separate applicator roll 35 is carried out in that a spraying device 41 sprays the conditioning medium or rubber covering medium immediately or directly onto the separate applicator roll 35 in the direction of the arrows 42. In this case, the metering can be carried out via liquid pressure or via a separate pump.

FIG. 8a shows an exemplary embodiment having an additional smoothing roll 53 which can roll on the applicator roll 35, which means that even small quantities of the conditioning medium or rubber covering medium can be applied very uniformly.

In the exemplary embodiment of FIG. 9, on the other hand, the spraying device 41 applies the rubber covering medium or conditioning medium indirectly to the separate applicator roll 35 in that the spraying device 41 sprays the rubber covering medium or conditioning medium onto a cloth which, in analogy with the exemplary embodiment of FIGS. 1 to 4, then transfers the conditioning medium or rubber covering medium to the applicator roll 35.

It should be mentioned at this point that the applicator roll 35 can of course be a conventional roll 51, for example already present in the printing unit.

In the exemplary embodiments according to FIGS. 5 to 9 there is the possibility that the application of the conditioning medium or rubber covering medium to the separate applicator roll 35 is carried out either in one step over the width of the cylinder or by traversing section by section. In the case of the application of the conditioning medium or rubber covering medium to the separate applicator roll 35 by traversing section by section or traversing continuously, the corresponding device must be moved in the direction of an axis of rotation or longitudinal axis of the separate applicator roll 35, along the surface of the same, for this purpose. The drive already indicated above of the application roll 35 by means of friction can be implemented in the case of continuous traversing by means of a lateral offset of the application of the rubber covering medium or conditioning medium and the associated formation of a dry zone.

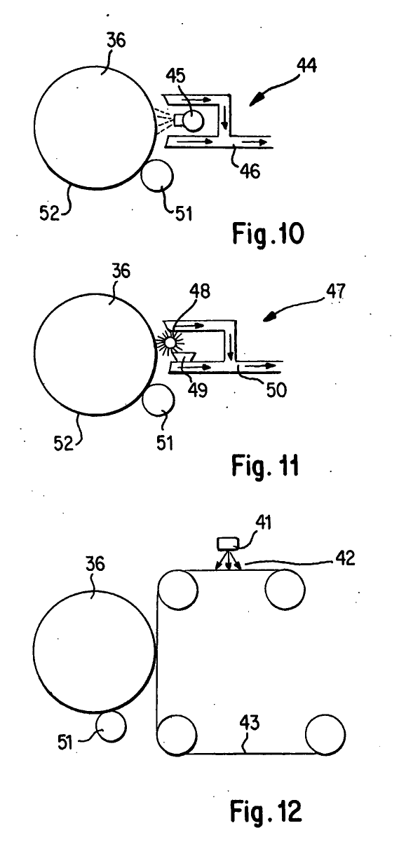

In the exemplary embodiments according to FIGS. 10 and 11, it is intended to indicate that, of course, in the case of the direct application of the conditioning medium or rubber covering medium to the form cylinder 36, use can be made of a separate spraying device 44 with spray nozzle 45 and extraction 46 or a separate device 47 with soft brush 48, which interacts with a dip trough 49 and likewise with extraction 50, in both the exemplary embodiments a roll already present in the printing unit or a smoothing roll 51 rolling over the printing form surface.

In the exemplary embodiment of FIG. 12, the spraying device 41 applies the rubber covering medium or conditioning medium to a cloth 43 which is set against the form cylinder 36 in order to transfer the medium, which is evened out by a roll already present in the printing unit or a smoothing roll 51. The application can be carried out either over the width of the cylinder or by traversing.

Finally, it should also be made clear that the application of the conditioning or rubber covering medium does not necessarily have to be carried out within a press but can of course also be performed during the setting up of erasable printing forms outside the press (for example by Sleevesetter).

### LIST OF REFERENCE SYMBOLS

10 Printing unit
11 Printing material
12 Form cylinder
13 Form cylinder
14 Rubber covered cylinder
15 Rubber covered cylinder
16 Washing device
17 Cleaning cloth
18 Clean cloth roll
19 Spraying device
20 Pressing element
21 Dirty cloth roll
22 Feed line
23 Crossmember
24 Arrow
25 Arrow
26 Arrow
27 Film
28 Arrow
29 Arrow
30 Arrow
31 Film
32 Arrow
33 Arrow
34 Arrow
35 Applicator cylinder
36 Form cylinder
37 Dip bath
38 Intermediate cylinder
39 Doctor device
40 Thin-film producing device
41 Spraying device
42 Arrow
43 Cloth
44 Separate spraying device
45 Spray nozzle
46 Extraction
47 Separate device with brush
48 Brush
49 Dip trough
50 Extraction
51 Roll
52 Printing form surface
53 Additional smoothing roll

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for applying a medium, especially a conditioning medium or a rubber covering medium, to a printing form positioned on a form cylinder, especially to a rewritable and erasable printing form, wherein the medium is applied to a rubber covered cylinder or to a separate applicator roll for the medium, and wherein the medium is then transferred from the rubber covered cylinder or applicator roll to the form cylinder, in this case the rubber covered cylinder or the applicator roll or a smoothing roll rolling repeatedly over the form cylinder in order to ensure a uniform application of the medium to the printing form, or in that the medium is applied to the form cylinder directly, especially by means of a spraying device or a cloth, in particular a cleaning cloth of a washing device, or a brush, especially of a separate device.

2. The method according to claim 1, wherein, during the transfer of the medium to the printing form, the rubber covered cylinder or the applicator roll is driven by a motor or by friction in such a way that a surface speed of the rubber covered cylinder or of the separate applicator roll corresponds approximately to a surface speed of the form cylinder.

3. The method according to claim 1, wherein the medium is applied to the rubber covered cylinder and wherein the medium is then transferred from the rubber covered cylinder to the form cylinder, the rubber covered cylinder being set against the form cylinder for this purpose.

4. The method according to claim 3, wherein following the transfer of the medium from the rubber covered cylinder to the form cylinder, the rubber covered cylinder is set off the form cylinder and is cleaned.

5. The method according to claim 3, wherein the medium is applied to the rubber covered cylinder directly or immediately in such a way that the medium is sprayed onto the rubber covered cylinder.

6. The method according to claim 3, wherein the medium is applied to the rubber covered cylinder indirectly in such a way that the medium is applied to the rubber covered cylinder with aid of a cleaning cloth.

7. The method according to claim 3, wherein the medium is applied to the rubber covered cylinder over a width of the cylinder, by traversing section by section or by traversing continuously.

8. The method according to claim 1, wherein the medium is applied to the separate applicator roll and in that the medium is then transferred from the separate applicator roll to the form cylinder.

9. The method according to claim 8, wherein the separate applicator roll is provided at a width of the form cylinder and for the application of the medium by traversing section by section.

10. The method according to claim 8, wherein the separate applicator roll is provided in a considerably shorter form than the form cylinder and traverses continuously in order to apply the medium to the form cylinder.

11. The method according to claim 8, wherein the medium is applied to the applicator roll over a width of the roll, by traversing section by section or by traversing continuously.

12. The method according to claim 8, wherein the medium is applied to the separate applicator roll in such a way that the medium is sprayed onto the applicator roll.

13. The method according to claim 8, wherein the medium is applied to the separate applicator roll in such a way that the medium is applied to the applicator roll by a doctor device.

14. The method according to claim 8, wherein the medium is applied to the separate applicator roll by an intermediate cylinder, by traversing section by section or by traversing continuously.

15. An apparatus for applying a medium, especially a conditioning medium or a rubber covering medium, to a printing form positioned on a form cylinder, especially to a rewritable and erasable printing form, wherein the medium is transferable to the form cylinder or the printing form via a rubber covered cylinder assigned to the form cylinder or via a separate applicator cylinder or smoothing roll assigned to the form cylinder, or directly to the form cylinder or printing form by means of a spraying device or a cloth, especially of a washing device, or a brush, especially of a separate device.

16. The apparatus according to claim 15, wherein, in order to transfer the medium to the printing form, the rubber covered cylinder or the applicator cylinder is drivable in such a way that a surface speed of the rubber covered cylinder or of the separate applicator cylinder corresponds approximately to a surface speed of the form cylinder.

17. The apparatus according to claim 15, wherein the rubber covered cylinder is assigned a washing device via which, firstly, the medium is transferable to the rubber covered cylinder and via which, secondly, following a transfer of the medium from the rubber covered cylinder to the form cylinder, the rubber covered cylinder is cleanable.

18. The apparatus according to claim 17, wherein the washing device comprises a spraying device, via which, firstly, the medium is transferable to the rubber covered cylinder and via which, secondly, following the transfer of the medium from the rubber covered cylinder to the form cylinder, a cleaning agent is transferable to the rubber covered cylinder.

19. The apparatus according to claim 18, wherein the spraying device sprays the medium and the cleaning agent immediately or directly onto the rubber covered cylinder or applies it to the rubber covered cylinder indirectly via a cleaning cloth.

20. The apparatus according to claim 15, wherein the separate applicator cylinder is assigned a device via which the medium is transferable to the separate applicator cylinder.

21. The apparatus according to claim 20, wherein the device is a spraying device which is either an individual spray nozzle, which applies the medium to the separate applicator cylinder by traversing section by section or by traversing continuously, or is a spray bar, which applies the medium to the separate applicator cylinder over a width of the cylinder.

22. The apparatus according to claim 20, wherein the device is a doctor device.

23. A method for applying a medium to a form cylinder, comprising the steps of:
applying the medium to a rubber covered cylinder by a washing device of the rubber covered cylinder; and
transferring the medium from the rubber covered cylinder to the form cylinder.

24. The method according to claim 23, wherein the medium is a conditioning medium or a rubber covering medium.

25. A method for applying a medium to a form cylinder, comprising the steps of:
applying the medium to an applicator roll; and
transferring the medium from the applicator roll to the form cylinder.

26. The method according to claim 25, wherein the step of applying the medium to the applicator roll includes the steps of applying the medium to an intermediate cylinder from a dip bath and rolling the intermediate cylinder on the applicator roll.

27. The method according to claim 25, wherein the medium is applied to the applicator roll via a doctor device.

28. The method according to claim 25, wherein the medium is applied to the applicator roll via a thin-film producing device.

29. The method according to claim 25, wherein step of applying the medium to the applicator roll includes the step of spraying the medium on the applicator roll by a spraying device.

30. The method according to claim 25, wherein step of applying the medium to the applicator roll includes the steps of spraying the medium onto a cloth and transferring the medium from the cloth to the applicator roll.

31. A method for applying a conditioning medium or a rubber covering medium to a form cylinder, comprising the step of:
spraying the conditioning medium or the rubber covering medium on the form cylinder by a spraying device.

32. A method for applying a medium to a form cylinder, comprising the steps of:
dipping a brush in the medium in a dip trough; and
brushing the medium on the form cylinder by the brush.

33. A method for applying a conditioning medium or a rubber covering medium to a form cylinder, comprising the steps of:
spraying the conditioning medium or the rubber covering medium on a cloth by a spraying device; and
transferring the conditioning medium or the rubber covering medium from the cloth to the form cylinder.
